(19) United States
(12) Patent Application Publication
(10) Pub. No.: US 2015/0165393 A1
(43) Pub. Date: Jun. 18, 2015

(54) MOBILE INTEGRATED CONTINUOUS PROCESSING SYSTEM

(71) Applicant: INTEGRATED LATH AND PLASTER, LLC, Scottsdale, AZ (US)

(72) Inventor: Scott Lawrence Schuster, Scottsdale, AZ (US)

(73) Assignee: INTEGRATED LATH AND PLASTER, LLC, Scottsdale, AZ (US)

(21) Appl. No.: 14/571,743

(22) Filed: Dec. 16, 2014

Related U.S. Application Data
(60) Provisional application No. 61/963,789, filed on Dec. 16, 2013.

(51) Int. Cl. B01F 3/12; B01F 15/06; B01F 15/02; B01F 13/00

(52) U.S. Cl. CPC B01F 3/1271; B01F 13/004; B01F 3/1214; B01F 15/06; B01F 15/0234; B01F 2015/061

(57) ABSTRACT

A mobile integrated continuous processing system for mixing and distributing hydrated construction materials having a system frame, including a coupling mechanism for selective engagement with an associated vehicle for transport to a worksite and selective disengagement from the vehicle for stand-alone operation, a mixing assembly including components for mixing dry construction materials with water of a temperature selected by a user to produce a hydrated construction material, a lifting mechanism for hoisting dry construction materials into a loading position in proximity to the mixing assembly, and a distribution assembly to expel hydrated construction materials from the mobile integrated continuous processing system.

This U.S. patent application claims priority to U.S. provisional patent application Ser. No. 61/963,789 filed on Dec. 16, 2013, which is incorporated herein by reference in its entirety.

### BACKGROUND

The traditional methods of mixing, processing and ultimately applying hydrated construction materials are often inefficient, inconsistent and otherwise problematic. For example, multiple dry materials are combined to produce stucco, grout, mortar and the like are often hand mixed on-site by workers of various skill levels often resulting in inconsistent and varying product quality. The manpower requirements of this approach are also excessive. On larger sites, pre-blended high quality manufactured dry material are delivered to the work site which reduces the consistency issues however the handle and processing of material is difficult and cumbersome. For example, one method of delivering the pre-blended dry product is to drop of 3,000 pound bags of the material at the job site. Unfortunately, the bulky bags are hard to handle and often require large capacity fork lifts, large and immobile material processing equipment and more. The aforementioned arrangement is especially problematic on job sites such as residential developments due to the relative immobility of the arrangement.

There is a need for a mobile, integrated and continuous material processor that significantly alters the work flow over traditional methods and results in a highly efficient, high quality and consistent application of construction materials such as stucco, grout, mortar and more regardless of the size of the construction job.

Further limitations and disadvantages of conventional, traditional, and proposed approaches will become apparent to one of skill in the art, through comparison of such systems and methods with embodiments of the present invention as set forth in the remainder of the present application with reference to the drawings.

### SUMMARY

Embodiments of the present invention provide a mobile integrated continuous processing system that provides high quality hydrated construction materials to a worksite.

Embodiments of the present invention facilitate continuous processing of dry construction materials into hydrated construction materials ready for application to a worksite location or surface.

Another advantage of the invention is the ability to process and hydrate only what is needed to complete job, in the process controlling waste, spoils, and negative effects on the environment.

Another advantage of the invention is the ability to apply materials in a highly efficient manor to reduce the need for extra manpower and reduce construction cycle time.

In one embodiment of the invention, a mobile integrated continuous processing system for mixing and distributing hydrated construction materials comprises a system frame, including a coupling mechanism for selective engagement with an associated vehicle for transport to a worksite and selective disengagement from the vehicle for stand-alone operation, a mixing assembly, operatively mounted to the system frame, including components for mixing dry construction materials with water of a temperature selected by a user to produce a hydrated construction material, a lifting mechanism, operatively mounted to the system frame, for hoisting dry construction materials into a loading position in proximity to the mixing assembly, and a distribution assembly, operatively mounted to the system frame, to expel a hydrated construction materials from the mobile integrated continuous processing system.

In another embodiment of the invention, a mobile integrated continuous processing system for mixing and distributing hydrated construction materials comprises a system frame, a mixing assembly adapted to mix dry construction materials having a hopper which can receive the entire contents of one or more 3,000 pound bags of pre-mixed dry construction materials, a lifting mechanism adapted to hoist dry construction materials into a loading position in proximity to the mixing assembly, and a distribution assembly adapted to expel a hydrated construction material from the mobile integrated continuous processing system.

In another embodiment of the invention, a method for providing a mobile continuous processing system comprises the steps of providing an apparatus comprising a system frame, a mixing assembly mounted to the system frame, a lifting mechanism mounted to the system frame, and a distribution assembly mounted to the system frame, providing an associated vehicle for selective engagement with the system frame, coupling the system frame to the vehicle, transporting the system frame to a worksite under the power of the associated vehicle, disconnecting the system frame from the vehicle at the worksite for stand-alone operation, using the lifting mechanism to hoist dry construction materials into the mixing assembly, producing hydrated construction materials by operation of the mixing assembly, and expelling hydrated construction materials from the integrated continuous processing system by operation of the distribution assembly.

These and other advantages and novel features of the present invention, as well as details of illustrated embodiments thereof, will be more fully understood from the following description and drawings.

### BRIEF DESCRIPTION OF THE DRAWINGS

FIG. 1 illustrates a side view plan diagram of a mobile integrated continuous processing system 100 according to one embodiment of the invention;

FIG. 2 illustrates a top perspective view of a mobile integrated continuous processing system 100 according to one embodiment of the invention;

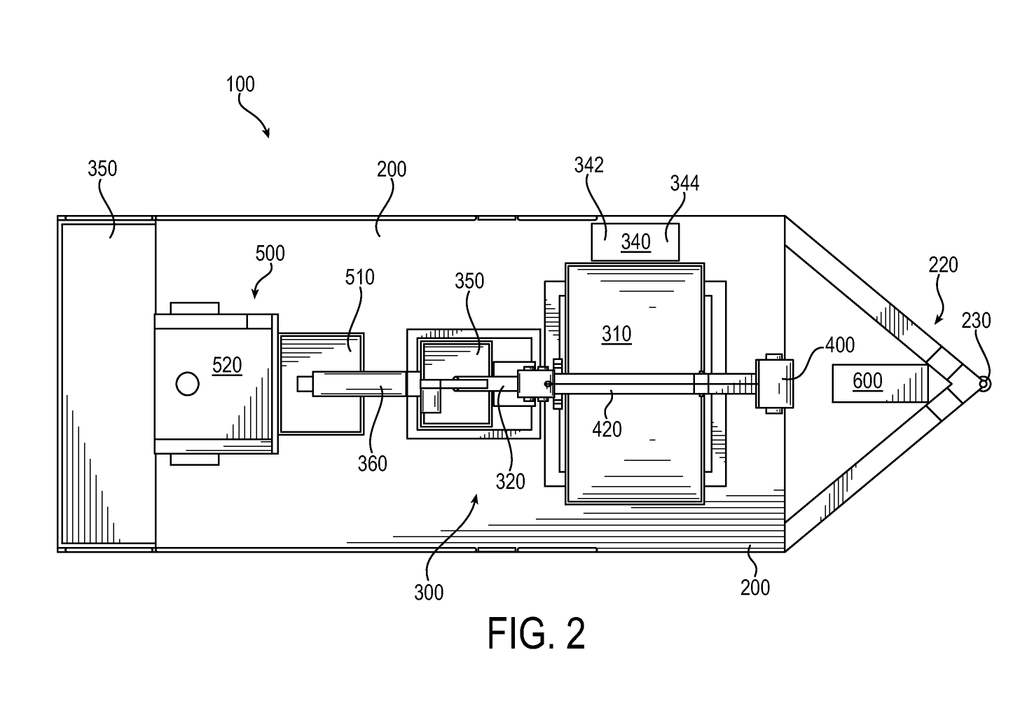

FIG. 3 shows illustrates a rear side perspective view of a mobile integrated continuous processing system according to one embodiment of the invention;

FIG. 4 illustrates another rear side perspective view of a mobile integrated continuous processing system 100 according to one embodiment of the invention, wherein the lifting mechanism is in operation.

FIG. 5 illustrates a side perspective view of a mobile integrated continuous processing system according to one embodiment of the invention, wherein the lifting mechanism and other system components are in operation.

FIG. 6 illustrates a side perspective view of a mobile integrated continuous processing system and associated vehicle according to one embodiment of the invention.

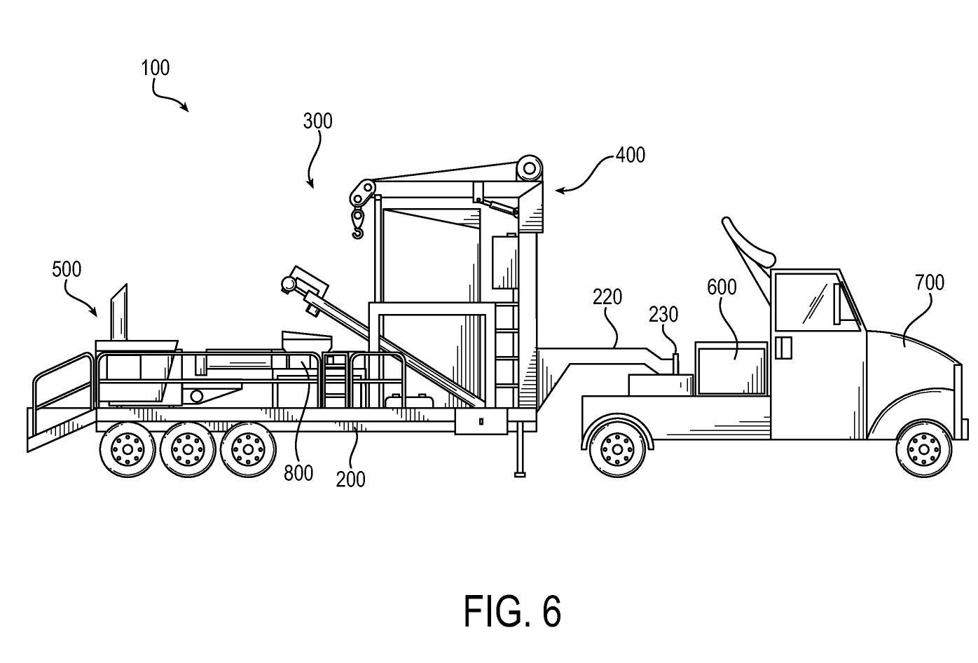

### DETAILED DESCRIPTION

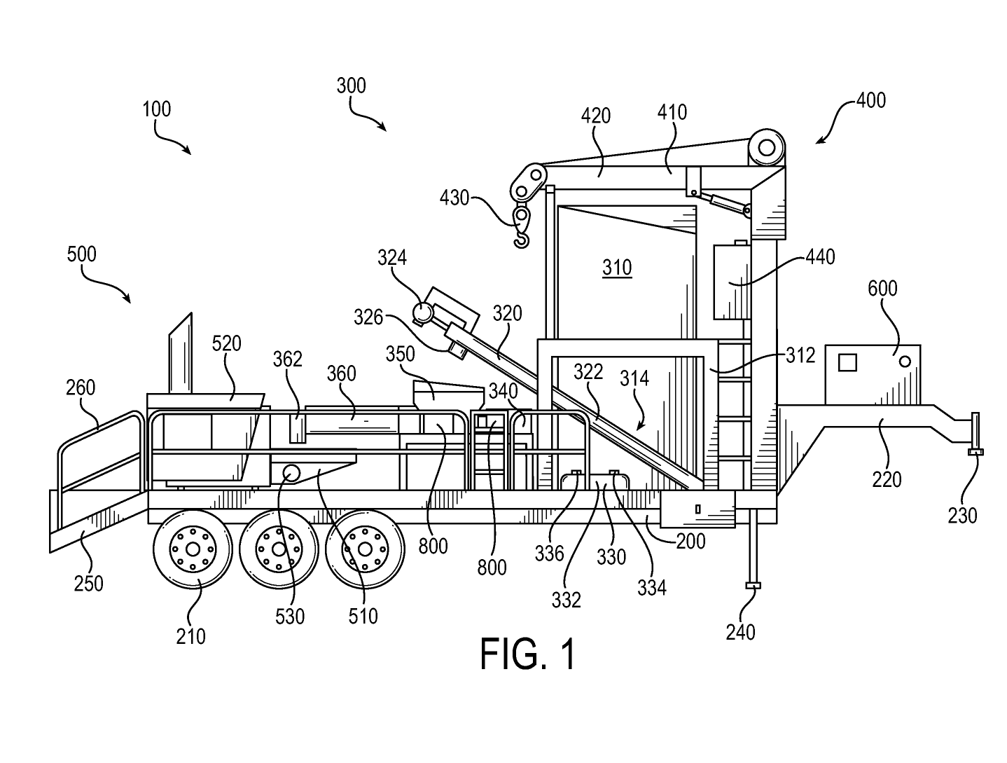

FIG. 1 illustrates a plan view diagram of an example embodiment of a mobile integrated continuous processing system 100. The system 100 includes various components operationally connected, as is well known to persons of ordinary skill in the art and further described below, to effectuate the continuous processing of a dry construction material into a hydrated construction material. For example, the system 100 may be used to process a dry construction material product, such as a 3,000 pound bag of pre-blended base coat stucco, into the hydrated construction material stucco that is sprayed onto a building surface. The system 100 is also configured to process other dry construction materials—such as concrete, mortar, grout or plaster—into a hydrated construction material that is ready for application at a building construction worksite.

With continuing reference to FIG. 1, the integrated continuous processing system 100 may consist of a system frame 200, mixing assembly 300, lifting mechanism 400, and distribution assembly 500. The system frame 200 shown in FIG. 1 is configured to be mobile, such as by being towed, for example, behind a truck or other vehicle 700. System frame 200 mobility may be provided by one or more wheels 210, in cooperation with a tongue 220 and hitch assembly 230 configured to selectively engage with an associated vehicle. The mobile system frame 200 permits delivery to a worksite, and selective movement between chosen points at a worksite, depending on user preferences. When the system 100 is delivered to the worksite, stabilizing mechanisms 240 may be moved from a first position adapted to permit transport to a worksite into a second position that stabilizes the system frame 200 into a substantially horizontal position on a ground surface. In some embodiments, the system frame may also have a storage stage 250 for retaining distribution assembly 500 components such as hoses 550, and/or guardrails 260. In one embodiment, the system 100 or system frame 200 and one or more of the mixing assembly 300, lifting assembly 400, and/or distribution assembly 500, may be fixed to a vehicle 700.

The system frame 200 is adapted to support one or more of the mixing assembly 300, lifting mechanism 400, and/or distribution assembly 500. The mobile system 100 can continuously process dry construction materials into hydrated construction materials through cooperation of system 100 components. The system 100 is intended to be delivered to a worksite, where after the lifting assembly 400 continuously secures and feeds—as necessary—the contents of bulk dry construction material bags for processing in the mixing assembly 300 and delivery to a desired worksite location or surface via the distribution assembly 500.

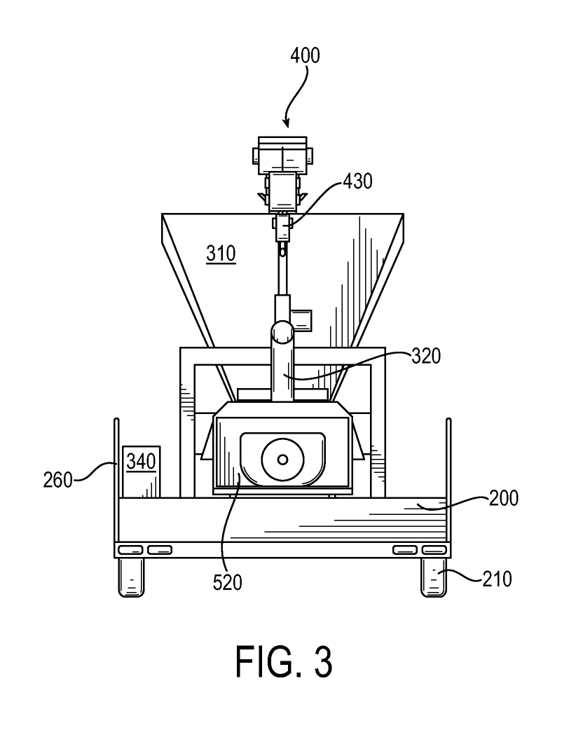

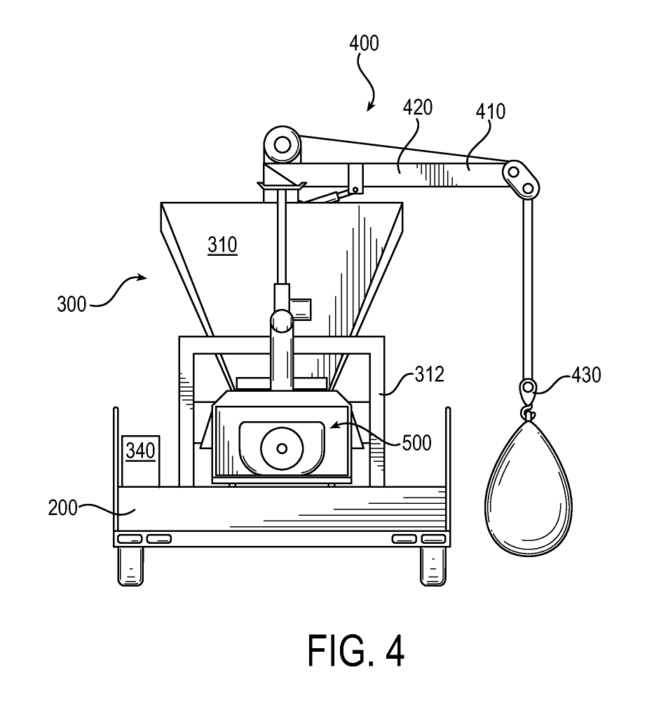

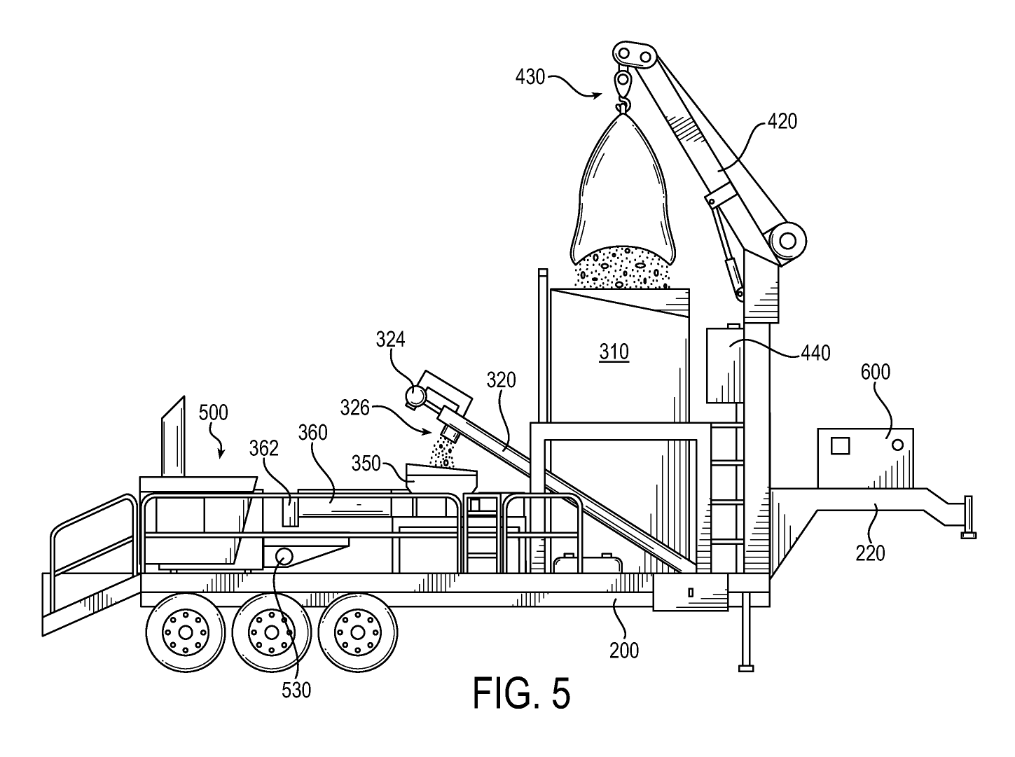

The lifting mechanism 400 is configured to hoist dry construction materials from a location near the system 100, such as a ground surface or delivery truck, into a position of selected proximity for receipt of dry construction materials into the mixing assembly 300. The lifting mechanism 400 may be mounted to the system frame 200, or may be mounted onto an associated vehicle 700. In one embodiment, the lifting mechanism 400 is a crane 410 having one or more boom or lift arms 420 and a hoist device 430. As shown in FIGS. 3-5, the lift arm 420 and hoist device 430 may be selectively rotatable between, at least, a first position configured to have the hoist device 430 engage an associated container of dry construction materials (FIG. 4), and a second position configured to deliver the dry construction materials container into sufficiently close proximity of the mixing assembly 300 for receipt of dry construction materials (FIG. 5). The lift arm 420 may also be adapted for vertical movement and/or telescopic horizontal movement. The hoist device 430 may consist of a hoist line and ball and hook arrangement, or any other assembly selected by a person of skill in the art. The lifting mechanism 400 may be powered by a hydraulic system 440, or any other mechanical device adapted to move a lifting mechanism, as is well-known in the art. The power source for the hydraulic system 430 may be a gas or electric generator 600, said generator 600 being mounted to one or more of the system frame 200, lifting mechanism 400, and/or associated vehicle 700. Alternatively, the lifting mechanism 400 may be powered by an integral or other associated power source.

The mixing assembly 300 is adapted for continuous receipt and processing of dry construction materials delivered by the lifting mechanism 400 into a hydrated construction material. The mixing assembly 300 may comprise one or more of a dry construction materials storage hopper 310, conveyor mechanism 320, liquid source 330, liquid temperature control unit 340, mixer bin/dry mixer 350, and continuous mixer 360. In operation, the hopper 310 is adapted to receive dry construction materials, which are selectively transported by the conveyor mechanism 320 out of the hopper 310 and into the mixer bin/dry mixer 350, wherein the continuous mixer 360 mixes (processes) selected amounts of liquid and dry construction material to produce a hydrated construction material.

The dry construction materials storage hopper 310 is fixedly mounted onto the system frame 200, and/or a hopper frame 312 (which may support one or more of portions of the lifting assembly 400 or hopper 310) secured to the system frame 200. As shown in FIG. 5, the top opening of the hopper 310 is adapted to receive dry construction materials flowing from a container properly aligned by the lifting mechanism 400 above the opening 312. In various embodiments, the hopper 310 may take any shape chosen by a person of sound engineering judgment. The hopper 310 is of sufficient capacity to permit continuous processing of dry construction materials into hydrated construction materials; which is to say the hopper 310 can store enough dry construction material from a first container that mixing can continue without interruption as the lifting mechanism 400 moves associated dry construction material containers from a ground surface into a position where the hopper receives a portion of materials from a second container. In one embodiment, the hopper 310 can receive the full contents of between one and three 3,000 pound bulk storage bags of dry construction materials; in another embodiment, the hopper 310 can receive between 2,000 and 3,000 pounds of dry construction materials; in yet other embodiments, the hopper 310 can receive and store between 1,000 and 2,000 pounds of dry construction materials; in yet additional embodiments, the hopper 310 can receive and store less than 1,000 pounds of dry construction materials.

The hopper 310 may have an aperture 314 which is adapted to release dry construction materials into a conveyor mechanism 320 for transport to the mixer bin/dry mixer 350. The conveyor mechanism 320 may consist of an auger assembly 322 that is adapted to pull dry construction materials flowing out of the hopper 310 along a route that ends at the mixer bin/dry mixer 350. In one embodiment, the auger assembly 322 may additionally comprise a variable speed motor 324 that is adapted to vary the speed of the auger and control the amount of dry construction material being deposited into the mixer bin/dry mixer 350. The variable speed motor 324 may be powered by an integral or associated dedicated power source, or by the system generator 600. In one embodiment, the auger assembly terminates in an outlet spout 326 which is in close proximity to the mixer bin/dry mixer 350; in other embodiments, the outlet spout 326 feeds directly into the mixer bin/dry mixer 350. In some embodiments, the variable speed motor 324 delivers a selected amount of dry construction materials into the mixer bin/dry mixer 350 based on user input entered into a controller 800.

The mixing assembly 300 may also have a liquid source 330 that is in fluid communication with a continuous mixer 360 and/or the mixer bin 350, and may have a pump adapted to deliver a selected amount of liquid into the continuous mixer 360 and/or bin 350 for the processing of a dry construction material into a hydrated construction material. The liquid source 330 may comprise a stand-alone tank 332 of sufficient capacity to permit continuous processing of construction materials. The liquid source might alternatively comprise one or more intake assemblies 334 that are adapted to receive liquid from an external water source such as a garden hose. In still other embodiments, the liquid source 330 may comprise the combination of both a storage tank 332 and a liquid intake assembly 334.

By way of one or more outtake assemblies 336, the liquid source 330 may be in direct fluid communication with the continuous mixer 360 and/or bin 350, or it may be in indirect communication with the continuous mixer 360 and/or bin 350 by virtue of its fluid connection to a liquid temperature control unit 340 which is in fluid connection with the liquid source 330 and/or the mixer bin 350. In one embodiment, the liquid temperature control unit 340 is a chiller 342 adapted to lower the ambient temperature of the liquid delivered into the continuous mixer 360 and/or bin 350; in other embodiments, the liquid temperature control unit 340 is a heater 344 adapted to increase the ambient temperature of the liquid that is to be delivered into the continuous mixer 360 and/or bin 350; in yet other embodiments, the liquid temperature control unit 340 may be a combination chiller 342 and heater 344 device. Adjustments to the temperature of liquids delivered into the continuous mixer 360 and/or bin 350 permit users to refine the quality or characteristics of hydrated construction materials produced, based on environmental factors such as the ambient temperature, or based on the dry construction material being processed in the system 100.

In various embodiments, the temperature of the water may be adjusted by sending water from either an outside water source or the storage tank 332 to the liquid temperature control unit 340, wherein circulation of the water within the liquid temperature control unit 340 adjusts the temperature to a desired level, followed by delivery of the water by an associated pump to one or more of the liquid storage tank 332, continuous mixer 360, or bin 350. The liquid temperature control unit 340 may be in communication with a controller 800, wherein the temperature of the liquid delivered to the continuous mixer 360, bin 350, and/or storage tank 332 is controlled by user inputs entered into the controller 800. In other embodiments, or by manual valve adjustment levers on continuous mixer 360 may effectuate the same control. In still other embodiments, one or more of the amount of dry construction material and the temperature of the liquids delivered into the continuous mixer 360, mixer bin 350, and/or storage tank 332 are determined by user inputs into one or more controllers 800. The liquid temperature control unit 340 may be powered by an integral or associated dedicated power source, or the system generator 600.

The mixer bin/dry mixer 350 may be configured to receive dry construction materials delivered by the conveyor mechanism 320 from the hopper 310, and may also be adapted to receive liquids. The continuous mixer 360 may be configured to receive dry materials from mixer bin/dry mixer 350 and liquids delivered from the liquid source 330 and/or liquid temperature control unit 340. The mixer bin/dry mixer 350 may be adapted to cooperate with an associated continuous mixer 360. Mixer bin/dry mixer 350 may auger dry construction materials to the continuous mixer 360, wherein liquids are introduced. The continuous mixer 360 may be attached to the mixer bin/dry mixer 350 and comprise a motor which drives portions—such as mixing paddles, augers, blades, tumblers, agitators, and the like—residing partially within the mixer bin/dry mixer 350, which may continue through to the continuous mixer 360. The continuous mixer 360 may also have a hydrated construction material outlet 362, said outlet 362 being in a position designed to expel hydrated construction materials into the distribution assembly 500. The continuous mixer 360 may be powered by an integral or associated power source, or the system generator 600.

The distribution assembly 500 is adapted to receive hydrated construction materials processed by the mixing assembly 300, and expel said materials from the system 100. The distribution assembly 500 may comprise one or more of a hydrated construction materials collection bin 510, a pump 520, and a dispensing outlet 530. The distribution assembly 500, specifically the dispensing outlet 530, may be adapted to apply the hydrated construction materials—for example, stucco mortar or grout—onto an surface, or location, by use of a hose and associated spray applicator (not shown, but known in the art). The pump 520 may be powered by an integral or associated power source, or by the system generator 600.

The integrated continuous processing system 100 provides numerous improvements over known devices as a result of its ability to continuously process dry construction materials into hydrated construction materials, that may be applied to surfaces via a pump and spray hose, or by other known delivery means, at various worksite locations. A method of providing a mobile integrated continuous processing system might comprise one or more of the following steps. First, providing a mobile system frame 200, a lifting mechanism 400 mounted to the system frame 200, a mixing assembly 300 mounted to the system frame 200, and a distribution system 500 mounted to the system frame 200, and an associated vehicle 700 for selective engagement with the system frame 200. Second, coupling the system frame 200 to the associated vehicle 700. Third, transporting the system frame 200 to a worksite. Fourth, disconnecting the system frame 200 from the associated vehicle 700 for stand-alone system 100 operation. Fifth, using the lifting mechanism 400 to continuously hoist dry construction materials into the mixing assembly 300, as necessary. Sixth, continuously producing hydrated construction materials by operation of the mixing assembly 300. Seventh, expelling hydrated construction materials from the integrated batch processing system 100 by operation of the distribution assembly 500.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiments disclosed, but that the claimed subject matter will include all embodiments falling within the scope of the appended claims.

What is claimed is:

1. A mobile integrated continuous processing system for mixing and distributing hydrated construction materials comprising:
a system frame, including a coupling mechanism for selective engagement with an associated vehicle for transport to a worksite and selective disengagement from the vehicle for stand-alone operation;
a mixing assembly, operatively mounted to the system frame, including components for mixing dry construction materials with water of a temperature selected by a user to produce a hydrated construction material;
a lifting mechanism, operatively mounted to the system frame, for hoisting dry construction materials into a loading position in proximity to the mixing assembly; and
a distribution assembly, operatively mounted to the system frame, to expel a hydrated construction materials from the mobile integrated continuous processing system.

2. The mobile integrated continuous processing system of claim 1, wherein the hydrated construction material is selected from the group consisting of grout, stucco, mortar and concrete.

3. The mobile integrated continuous processing system of claim 1, wherein the integrated continuous processing system adjusts operation based on a user input entered into an associated controller.

4. The mobile integrated continuous processing system of claim 1, wherein the mixing assembly has a liquid cooling unit for controlling the temperature of water, and the liquid cooling unit adjusts water temperature based on a user input entered into an associated controller.

5. The mobile integrated continuous processing system of claim 1, wherein the lifting mechanism comprises a crane having one or more articulated arms operated by hydraulic cylinders.

6. The mobile integrated continuous processing system of claim 1, wherein the mixing assembly comprises:
a dry materials storage hopper;
a mixer bin;
a conveyor mechanism, for transporting a selected amount of dry construction materials within the dry materials storage hopper into the mixer bin;
a batch mixer, for mixing dry construction materials with water; and
a liquid source, in fluid connection with the batch mixer.

7. The mobile integrated continuous processing system of claim 6, wherein the conveyor mechanism comprises an auger assembly.

8. The mobile integrated continuous processing system of claim 7, wherein the auger assembly further comprises a variable speed motor for adjusting the amount of dry construction materials moved between the dry materials storage container and the mixer bin based on a user input entered into an associated controller.

9. The mobile integrated continuous processing system of claim 1, wherein the system frame further comprises:
one or more wheels for transport of the integrated continuous processing system as a trailer to an associated vehicle; and
one or more stabilizing mechanisms for operatively supporting the system frame when it is uncoupled from the associated vehicle.

10. The mobile integrated continuous processing system of claim 1, further comprising a power source generator operable to provide power to one or more of the lifting mechanism, mixing assembly, and distribution assembly.

11. The mobile integrated continuous processing system of claim 1, wherein the distribution assembly comprises:
a hydrated construction materials bin;
a pump, in operative connection with the hydrated construction materials bin; and
a dispensing outlet for expelling hydrated construction materials from the mobile integrated continuous processing system.

12. A mobile integrated continuous processing system for mixing and distributing hydrated construction materials comprising:
a system frame;
a mixing assembly, adapted to mix dry construction materials, having a hopper which can receive the entire contents of one or more 3,000 pound bags of pre-mixed dry construction materials;
a lifting mechanism, adapted to hoist dry construction materials into a loading position in proximity to the mixing assembly; and
a distribution assembly, adapted to expel a hydrated construction material from the mobile integrated continuous processing system.

13. A method for providing a mobile continuous processing system, comprising the steps of:
providing an apparatus comprising a system frame, a mixing assembly mounted to the system frame, a lifting mechanism mounted to the system frame, and a distribution assembly mounted to the system frame;
providing an associated vehicle for selective engagement with the system frame;
coupling the system frame to the vehicle;
transporting the system frame to a worksite under the power of the associated vehicle;
disconnecting the system frame from the vehicle at the worksite for stand-alone operation;
using the lifting mechanism to hoist dry construction materials into the mixing assembly;
producing hydrated construction materials by operation of the mixing assembly; and
expelling hydrated construction materials from the integrated batch processing system by operation of the distribution assembly.
